(19) United States
(12) Patent Application Publication
(10) Pub. No.: US 2019/0072066 A1
(43) Pub. Date: Mar. 7, 2019

(54) HYDROELECTRIC DEVICE AND HYDROELECTRIC SYSTEM COMPRISING SAME

(71) Applicant: Mplus Co., Ltd., Yongin-si (KR)

(72) Inventor: Choon Teak Oh, Suwon-si (KR)

(73) Assignee: Mplus Co., Ltd.

(21) Appl. No.: 15/891,560

(22) Filed: Feb. 8, 2018

(30) Foreign Application Priority Data
Sep. 1, 2017 (KR) 10-2017-0111979

(51) Int. Cl. F03B 17/06; F03B 11/00; F03B 11/02

(52) U.S. Cl. CPC F03B 17/063; F03B 11/02; F03B 11/006

(57) ABSTRACT

A hydroelectric device to be placed on/in the flowing water includes a housing having a plurality of wings attached to rotate the housing by the flow of flowing water, a generator module received in the housing and having a rotating shaft that rotates by the rotation of the housing so as to convert the rotational energy of the rotating shaft into electrical energy, and flotation devices coupled to the housing so as to allow the hydroelectric generator to float in the flowing water.

### REFERENCE TO RELATED APPLICATIONS

This application claims the priority benefit of Korean Patent Application No. 10-2017-0111979 filed on Sep. 1, 2017, the entire contents of which are incorporated herein by reference.

### FIELD OF THE INVENTION

The present disclosure is directed to a hydroelectric device/generator and a hydroelectric system comprising the same.

### BACKGROUND OF THE INVENTION

Hydroelectric power generation is a method of generating electric power by typically installing small hydro turbine generators on the penstocks of a dam to use the dammed water to generate electricity. However, as such small hydro turbine generators depend on the strength of the high speed flow that results when traditional dams open their floodgates, they have limited versatility as they are only used on dam penstocks or other places where there is a sufficient level of high speed flow, and when installed and used in a location that does not have a dam or floodgate, it is difficult to reach the desired level of power generation.

Furthermore, most of these small hydro turbine generators are located in areas with large differences in elevation, and such areas with large differences in elevation are becoming scarcer due to land development efforts. In addition, when hydroelectric dams are built, the ecology of the area is impacted even if fishways are installed as the movement of aquatic life going up and down stream is blocked. As such, in the field of hydroelectricity, there is a need for research on hydroelectric devices that are free from the locational limitations of the hydroelectric power plants and that can be applied in a broader range of locations.

### SUMMARY OF THE INVENTION

According to one embodiment of the present invention, a hydroelectric device/generator is provided, which is to be installed in the flowing water while floating in the water.

According to another embodiment of the present invention, a hydroelectric system is provided, which delivers the electrical energy generated by a plurality of hydroelectric devices to land or intended locations through a transmission system.

According to one aspect of the present disclosure, there is provided a hydroelectric device, which is installed on/near the surface of flowing water. The hydroelectric device preferably includes a housing with a plurality of fins/wings, which rotates due to the flow of flowing water; a generator module that is installed inside the housing and has a rotating shaft that rotates by the rotation of the housing, and thereby converts the rotational energy of the rotating shaft to electrical energy; caps that are installed on the ends of the generator module to prevent the flowing water from penetrating into the generator module and that remain as a non-rotating element relative to the housing; and a flotation device that is connected to the caps or the housing and causes the housing and the generator module to float on the flowing water.

According to one embodiment, the generator module includes an internal housing that is installed inside the housing, a stator that is installed within the internal housing and contains a coil, and a rotator that includes permanent magnets and rotates inside of the stator along with the rotating shaft.

According to one preferred embodiment, the hydroelectric device can include a fixed pillar that is fixed to the bed of a flowing body of water; a connecting device that is connected to the fixed pillar utilizing one end of the connecting device; and a holding device that is fixed to the other end of the connecting device that is not connected to the fixed pillar and that holds the internal housing in place so that the internal housing is prevented from rotating in relation to the housing.

According to another preferred embodiment, the hydroelectric device can include a weighting device that is heavier than the flowing water; a connecting device that is connected to the weighting device with one end of the connecting device; and a holding device that is affixed to the other end of the connecting device that is not connected to the weighting device, and that holds the internal housing in place so that the internal housing is prevented from rotating in relation to the housing.

According to another embodiment, the connecting device can be configured to pull the holding device in the direction opposite to the flowing direction of the flowing water.

According to one preferred embodiment, the housing can be an impeller housing that has a cylindrical shell with a plurality of fins/wings on its outer surface.

According to one preferred embodiment, a step-up gear device that is configured to increase the rotation numbers or speed of the rotating shaft is added, and the step-up gear device can include a first gear that has its outer circumference coupled to the housing so as to rotate together with the housing and with gear teeth formed at its inner circumference, a second gear that engages with the first gear, and a third gear that engages with the second gear and rotates together with the rotating shaft.

According to one preferred embodiment, the diameter of the first gear is configured to be larger than the diameters of both the second and third gears.

According to one preferred embodiment, the rotating shaft of the second gear is fixed to the inner housing.

According to one preferred embodiment, an inner cap is provided between the inner housing and the cap and closes off one end of the inner housing.

According to one preferred embodiment, a first bearing is provided between the housing and the inner housing and that allows the housing to rotate around the inner housing and the inner cap.

According to one preferred embodiment, a second bearing is provided between the housing and the inner caps and that allows the housing to rotate around the inner housing and the inner caps.

According to one preferred embodiment, a third bearing and fourth bearing are provided, wherein the third bearing is disposed between the inner cap and the rotating shaft and the fourth bearing is disposed between the inner housing and the rotating shaft.

According to one preferred embodiment, a first sealing device is provided that is interposed between the cap and the housing.

According to one preferred embodiment, the generator module can include a second sealing device that is interposed between the rotating shaft and the inner housing.

According to one preferred embodiment, a third sealing device can be added that is located between the inner cap and the inner housing.

According to one preferred embodiment, an electrical energy storage device that is buried under the bed of the flowing water can be added, and the electrical energy storage device is electrically connected to the generator module in order to store the electrical energy generated by the generator module.

According to another aspect/embodiment of the present disclosure, a hydroelectric system is provided to harvest energy from flowing water, in which the hydroelectric system can include a plurality of fixed pillars that are fixed to the bed of the flowing water, a plurality of hydroelectric devices that are connected/coupled to each fixed pillar, and a transmission device that transmits the electrical energy generated by the plurality of hydroelectric devices to an intended location. The hydroelectric devices preferably include: a housing with a plurality of fins/wings that rotate due to the flow of flowing water; a generator module that is installed inside the housing and has a rotating shaft that rotates by the rotation of the housing, and that converts the rotational energy of the rotating shaft into electrical energy; caps that are installed on the ends of the generator module to prevent the flowing water from penetrating into the generator module; and a flotation device that is connected to the caps and causes the housing and the generator module to float on the flowing water.

According to the present invention, the hydroelectric device is advantageous in that it can be installed on a wide variety of locations with flowing water.

According to the present invention, electrical energy can be generated through relative rotation of the housing about the inner housing.

In addition, the electrical energy generated by the hydroelectric device can be stored by the electrical energy storage device.

In addition, a plurality of hydroelectric devices and transmission devices can be connected to transmit a large amount of electrical energy to land.

### BRIEF DESCRIPTION OF THE DRAWINGS

FIG. 1 is a perspective view of a hydroelectric generator according to one embodiment.

FIG. 2 is an exploded perspective view of the hydroelectric device and holding device for the hydroelectric generator depicted in FIG. 1.

FIG. 3 is a cross-sectional view of the hydroelectric device depicted in FIG. 2, that is cut along the direction of I-I.

FIG. 4 is an exploded perspective view of the hydroelectric device depicted in FIG. 2, viewed from the R₁ side.

FIG. 5 is an exploded perspective view of the hydroelectric device depicted in FIG. 2, viewed from the R₂ side.

FIG. 6 is a cross-sectional view of the hydroelectric device depicted in FIG. 2, that is cut along the direction of II-II.

FIG. 7 is a cross-section view of the hydroelectric device depicted in FIG. 2, that is cut along the direction of III-III.

FIG. 8 is a perspective view of a hydroelectric generator according to another embodiment.

FIG. 9 is a perspective view of a hydroelectric generator according to another embodiment.

FIG. 10 is a perspective view of a hydroelectric system according to another embodiment.

### DETAILED DESCRIPTION OF THE INVENTION

The embodiments set forth in the present disclosure are examples provided for the purpose of explaining the technical concepts of the present disclosure. The scope of the claims that follows from the present disclosure is not limited by the particular embodiments set forth below or by the details of such embodiments.

All of the technical and scientific terms used in the present disclosure are to have the meanings or definitions that are known to a person having ordinary skill in the technical field that pertains to the present disclosure, unless the terms are otherwise specifically defined. The terms used in the present disclosure have been used for the purpose of explaining or illustrating the present disclosure, and have not been selected for the purpose of limiting the scope of the claims of the present invention.

The terms “include/including”, “have/having”, “with”, and other similar terms must be understood to be open-ended terms that include the possibility of having other elements, unless otherwise defined by the phrase or sentence that includes the terms in question.

Any singular forms/terms set forth in the present disclosure can include the plural forms/terms thereof unless stated otherwise, and this applies to singular forms/terms used in the enclosed claims as well.

The terms such as “first” and “second” and similar as used in the present disclosure are included for the purpose of simply differentiating multiple elements from one another, and do not intended to limit the order or importance of any of the relevant elements.

For the present disclosure, when it is written that one element is “connected/coupled” to another element, this is to be understood to mean that either the one element can be directly connected or coupled to the other element, or it can mean that the two elements are connected or coupled to each other through yet another different element.

Exemplary embodiments of the present invention are described below with references to the accompanying drawing figures. In the drawing figures, identical or equivalent elements are given with identical reference numbers. In addition, for the explanation of the embodiments set forth below, repeat descriptions of identical or equivalent elements can be omitted. However, when the description of a particular element is omitted in connection with certain embodiments, this does not mean that the element is not to be included in those embodiments, but to be referred to the description of such identical or equivalent elements.

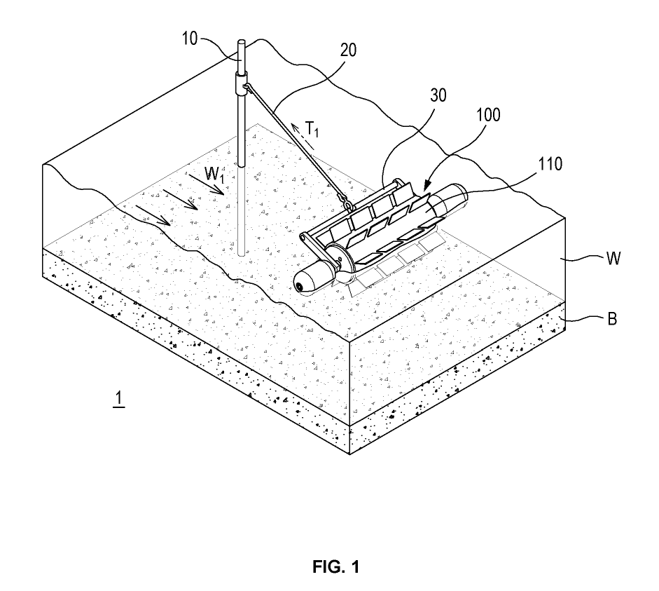

FIG. 1 is an exemplary perspective view of a hydroelectric generator according to one preferred embodiment of the invention.

Hydroelectric generator (1) can include a fixed pillar (10), connecting device (20), holding device (30), and hydroelectric device (100). The location of the fixed pillar (10) can be fixed by fixing or embedding the bottom end of the fixed pillar (10) into the bed (B) of the flowing body of water (W). For the connecting device (20), one end can be connected to the fixed pillar (10) and the other end can be connected to the holding device (30). The holding device (30) can hold the non-rotating portion of the hydroelectric device (100) so that the rotating portion of the hydroelectric device (100) can rotate relative to the non-rotating portion, and a more detailed explanation is provided below.

The flowing body of water (W) can include all forms of moving water in various locations such as oceans, rivers, lakes, and streams. For example, flowing water such as flowing rivers, ocean tides, and ocean waves can be used. Furthermore, the flow of the flowing water can occur naturally or can occur through artificial means. As another example, in a case where the fixed pillar (10) moves by being attached to a boat, the hydroelectric device (100) can be located on the flow of water that results from the movement of the boat. As such, the hydroelectric generator (1) of the invention is not required to be installed on a large structure such as a dam, and the hydroelectric generator (1) can generate electrical energy in an environmentally friendly way.

According to one embodiment, the connecting device (20) can be configured so as to pull the holding device (30) in the opposite direction (T1) to the flow of the flowing water (W1). In cases where the water does not flow, the connecting device (20) does not pull the holding device (30), so this may result in a situation where the hydroelectric device (100) is located near the fixed pillar (10). In contrast, in cases where the water is flowing in the direction of the flow (W1), the hydroelectric device (100) moves to a distance from the fixed pillar (10), and the connecting device (20) pulls the holding device (30) in the opposite direction (T1) to the direction of the flow (W1), and thus, the flow of the flowing water can make the housing (110) rotate. As a result, this process can convert the rotational energy of the housing (110) into electrical energy.

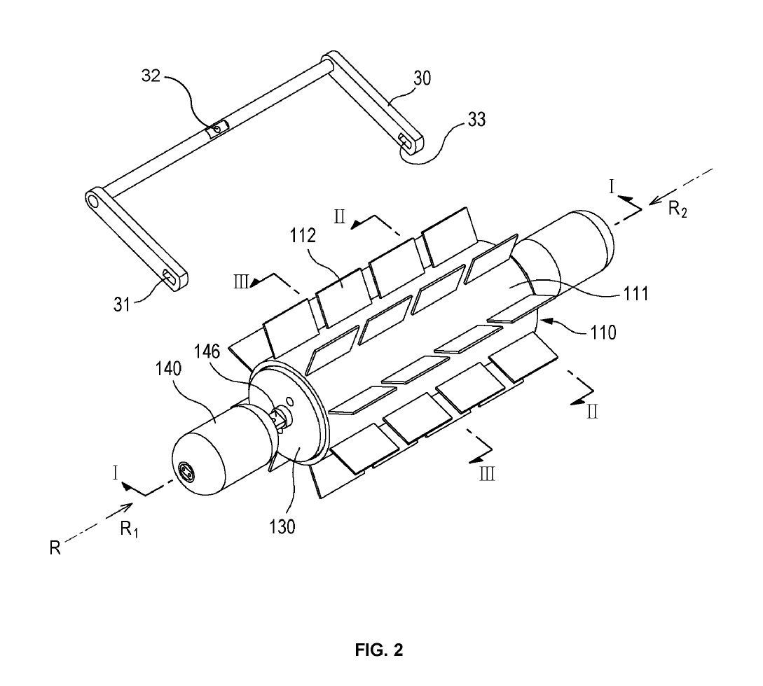

FIG. 2 is an exploded perspective view of the hydroelectric device (100) and holding device (30) for the hydroelectric generator (1) depicted in FIG. 1.

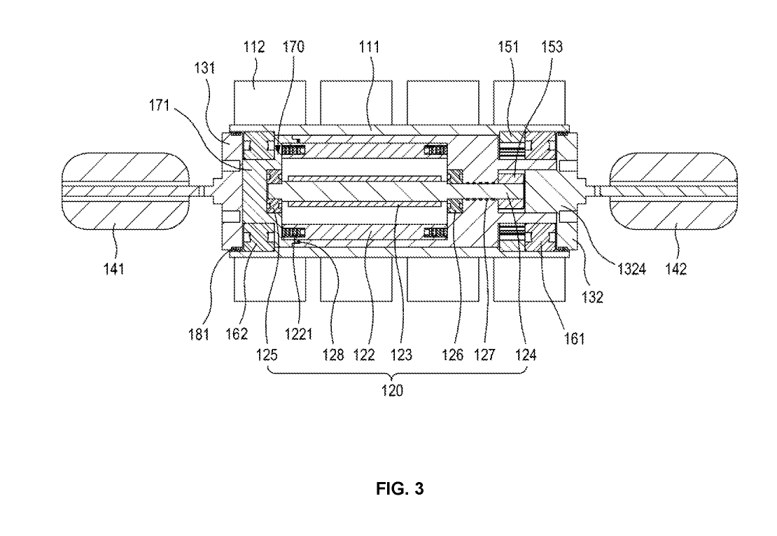

According to this embodiment, the housing (110) can be an impeller housing that has a plurality of fins/wings (112) fixed on the outer surface of a cylindrical shell (111). A generator module (120) depicted in FIG. 3 can be installed inside the cylindrical shell (111). The fins/wings (112) of the housing (110) can receive power from the flow of the flowing water and be rotated relative to the non-rotating portion/element of the generator module (120).

The hydroelectric device (100) preferably includes one or more caps (130) that can prevent the flowing water from entering the inside of the hydroelectric device (100), thereby preventing water from coming into contact with the generator module (120), and that can also act as a non-rotating element with respect to the housing (110). Furthermore, a flotation device (140) is connected to each of the caps (130), allowing the hydroelectric device (100) to float on or in the flowing water. The flotation device (140) can provide buoyancy for the housing of the hydroelectric device (100) so that the hydroelectric device (100) is not completely submerged underwater. For example, as depicted in FIG. 1, the amount of buoyancy provided by the flotation device (140) can be to a level such that roughly a half of the housing (110) is submerged under the flowing water.

The cap (130) can include a connecting bar (146) that extends in the axial direction (R). The cross-section of the connecting bar (146) can be in a polygonal shape. Furthermore, the holding device (30) can have first holes (31, 33) that have a shape that corresponds to the cross-section of the above connecting bar (146), and second hole (32) that is to be coupled to the other end of the connecting device (20) as shown in FIG. 1. As such, when the connecting bar (146) is inserted through the above first holes (31, 33), the cap (130) does not rotate around the holding device (30), and the location can be fixed. Furthermore, when the location of the connecting device (30) is fixed, the location of the cap (130) is also fixed, and the housing (110) can rotate relative to the cap (130). Therefore, the holding device (30) can hold the cap (130) so that the cap (130) does not rotate around the housing (110).

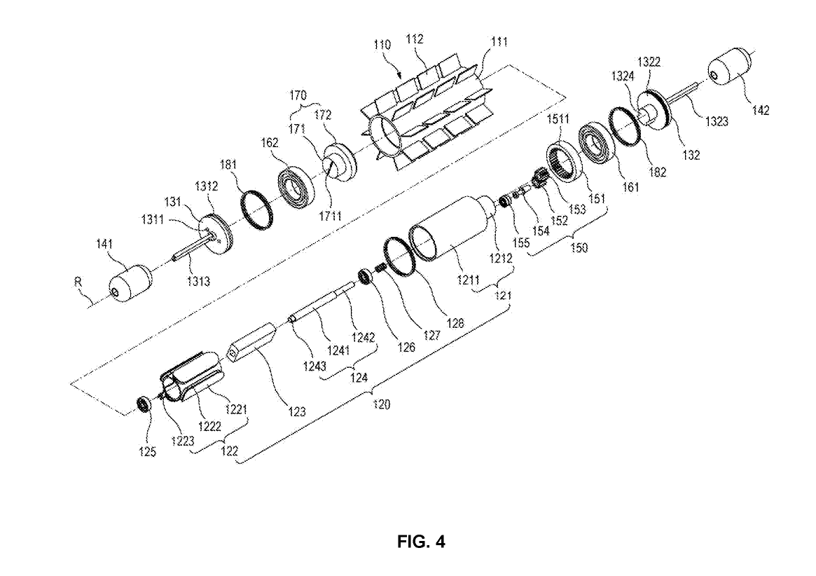

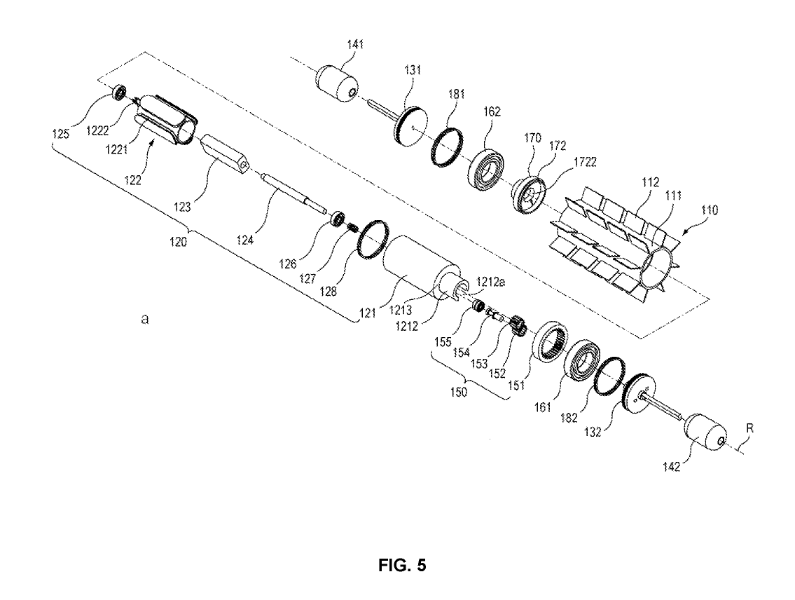

FIG. 3 is a cross-sectional view of the hydroelectric device (100) of FIG. 2, that is shown along the direction of I-I. FIG. 4 is an exploded perspective view of the hydroelectric device (100) of FIG. 2 viewed from the R1 side, and FIG. 5 is an exploded perspective view of the hydroelectric device (100) of FIG. 2 viewed from the R2 side.

With reference to FIGS. 3 through 5, the cap (130) can include a first cap (131) and a second cap (132) located opposite to the first cap (131) relative to the housing (110). In addition, the flotation device (140) can include a first flotation device (141) and a second flotation device (142) located opposite to the first flotation device (141) relative to the housing (110). The first cap (131) includes the first connecting bar (1313) that extends in the axial direction (R), and the second cap (132) includes the second connecting bar (1323) that extends in the axial direction (R). The first flotation device (141) can be coupled to the first cap (131) by the first connecting bar (1313) that runs through the first flotation device (141). Furthermore, the second flotation device (142) can be coupled to the second cap (132) by the second connecting bar (1323) that runs through the second flotation device (142). As such, the first and second flotation devices (141, 142) are located at both ends of the hydroelectric device (100), so both sides of the hydroelectric device (100) can float on/in the flowing water and not to be completely submerged.

According to one embodiment, the hydroelectric device (100) can include a generator module (120) that is received inside the housing (110). The generator module (120) can include an inner housing (121) that is received inside the housing, a stator (122) that has coils (1221) and is installed inside the inner housing (121), and a rotor (123) that includes permanent magnets and rotates along with the rotating shaft (124) inside of the stator (122). The rotating shaft (124) can be positioned to be parallel/coincident to the axial direction, and can go through the center of the generator module (120). Furthermore, the rotating shaft (124) can include a first part (1241) and a second part (1242) that has a diameter smaller than the first part (1241), and the first part (1241) can go through the rotor (123).

The stator (122) can include the main body (1221), a coil unit (1222) that is wound around the main body (1221), and a coupling unit (1223) that is disposed at the end of the coil unit (1222). The rotor (123) is positioned at the center of the main body (1221) so that the rotor (123) can rotate inside of the main body (1221). The coil unit (1222) can be wound around the outer circumference of the main body (1221). The coupling unit (1223) extends out from the coil unit (1222) and can go through the hole (1711) formed in the inner cap (170) and then go through the hole (1311) in the first cap (131).

The inner housing (121) can be separated from the housing (110) with a certain gap, and the housing (110) can rotate around the inner housing (121). Furthermore, the inner housing (121) can include a first part (1211) and a second part (1212) that has a smaller diameter than the first part. The length of the first part (1211) can correspond to the length of the stator (122).

According to one embodiment, the hydroelectric device (100) can include an inner cap (170) that is located between the inner housing (121) and the first cap (131). The inner cap (170) closes off the end of the first part (1211) of the inner housing (121). The inner cap (170) can include a first part (171) and a second part (172) that has a larger diameter than the first part (171). As depicted in FIG. 3, the end of the inner cap's (170) second part (172) can be coupled to the end of the inner housing's (121) first part (1211). Furthermore, the movement of the inner cap (170) is synchronized with the movement of the inner housing (121), and the housing (110) can rotate relative to the inner cap (170).

According to one embodiment, a step-up gear device (150) can be included that is configured to increase the rotations of the rotating shaft (124). The step-up gear device (150) can include a first gear (151) having its outer circumference (1511) coupled to the shell (111) of the housing (110) so as to rotate together with the housing (110) and including gear teeth at the inner circumference thereof, a second gear (152) that engages with the first gear (151), and a third gear (153) that engages with the second gear (152) and rotates along with the rotating shaft (124). For example, the first gear (151) can take the form of a ring gear, and the second and third gears (152, 153) can take the form of pinion gears. The end of the second part (1242) of the rotating shaft (124) can be inserted into the third gear (153).

According to one embodiment, the diameter of the first gear (151) can be configured to be larger than the diameters of both the second and third gears (152, 153). For example, when the ratio of the first gear (151) to the second and third gears (152, 153) is 3:1, the third gear (153) can rotate three times for every one time the first gear (151) rotates. Furthermore, as the difference in diameter between the first gear (151) and the second and third gears (152, 153) grows larger, the ratio can grow larger. As another example, when the diameter of the second gear (152) is larger than the diameter of the third gear (153), the ratio can grow further.

The rotating shaft (154) that rotates along with the second gear (152) can be located on the inner housing (121). As depicted in FIG. 5, the second part (1212) of the inner housing (121) can have a groove (1212a) formed on it, and the rotating shaft (154) can be located adjacent to the groove (1212a). In the area where the groove (1212a) is formed, the second gear (152) can rotate while not interfering with the second part (1212). Furthermore, the bearing (155) can be fixed on the coupling surface (1213) between the first part (1211) and the second part (1212). The rotating shaft (154) is pressed onto the inner ring of the bearing (155), and the rotating shaft (154) can rotate on the coupling surface (1213) due to the bearing (155). As such, the second gear (152) can rotate together with the rotating shaft (154).

Referring to FIG. 4, the second cap (132) can include an insertion protrusion (1324) that protrudes towards the inner housing (121). The insertion protrusion (1324) can have a shape that corresponds to the end of the second part (1212) of the inner housing (121). As depicted in FIGS. 3 and 4, the insertion protrusion (1324) can be inserted into the end of the second part (1212), and when the second cap (132) and the inner housing (121) is assembled, the insertion protrusion (1324) can be coupled to the groove (1212a).

According to one embodiment, the first bearing (161) is interposed between the shell (111) of the housing (110) and the inner housing (121). Furthermore, the second bearing (162) is interposed between the shell (111) of the housing (110) and the inner cap (170). The combination of the first bearing (161) and the second bearing (162) can allow for the housing (110) to rotate around the inner housing (121) and the inner cap (170). The outer circumference of the first bearing (161) is press fit against the inner circumference of the shell (111) in a location near the second cap (132), and the inner circumference of the first bearing (161) is press fit against the outer circumference of the second part (1212) of the inner housing (121). In addition, the outer circumference of the second bearing (162) is press fit against the inner circumference of the shell (111) in a location near the first cap (131), and the inner circumference of the second bearing (162) is press fit against the outer circumference of the first part (1212) of the inner cap (170).

The first and second bearings (161, 162) can both have an identical configuration. Furthermore, the areas formed by the inner circumferences of the first and second bearings (161, 162) can be identical. As such, the diameter of the first part (171) of the inner cap (170) can be identical to the diameter of the second part (1212) of the inner housing (121). In such a configuration, the drag produced by the first and second bearings (161, 162) can be identical, and the torque applied to the inner cap (170) and the inner housing (121) can also be identical.

According to one embodiment, the third bearing (125) can be interposed between the inner cap (170) and the rotating shaft (124). In addition, the fourth bearing (126) can be interposed between the rotating shaft (124) and the inner housing (121). As depicted in FIG. 5, a bearing receiving portion (1722) can be formed on the second part (172) of the inner cap (170) in order to receive the third bearing (125). The outer circumference of the third bearing (125) is press fit against the inner circumference of the bearing receiving portion (1722), and the inner circumference of the third bearing (125) is press fit against the outer circumference of the first end (1241) of the rotating shaft (124). In addition, the outer circumference of the fourth bearing (126) is press fit against the inner circumference of the second part (1212) of the inner housing (121), and the inner circumference of the fourth bearing (126) can be press fit against the outer circumference of the second part (1242) of the rotating shaft (124).

The third and fourth bearings (125, 126) can both have an identical configuration. Furthermore, the areas formed by the inner circumferences of the third and fourth bearings (125, 126) can be identical. For example, a bearing end (1243) can be formed on the end of the first part (1241) of the rotating shaft (124) and the diameter of the bearing end (1243) can be identical to the diameter of the second part (1242) of the rotating shaft (124). In such a configuration, the drag produced by the third and fourth bearings (125, 126) can be identical, and the torque applied to both ends of the rotating shaft (124) can also be identical.

The description of the sealing structure to prevent the entry of water into the hydroelectric device (100) is as follows. The first sealing device (181, 182), second sealing device (127), and third sealing device (128) can be in the form of rings, can be made of flexible materials, and as an example, can include rubber materials.

The first sealing device (181, 182) can include a pair of first sealing devices (181) and (182). The first sealing device (181) can be interposed between the first cap (131) and the shell (111) of the housing (110), and the first sealing device (182) can be interposed between the second cap (132) and the shell (111) of the housing (110). For one example, both the first and second caps (131, 132) can each have a groove (1312, 1322) formed on them, and the first sealing device (181) can be seated in the groove (1312) of the first cap (131) and the first sealing device (182) can be seated in groove (1322) of the second cap (132). As the first sealing device (181) and the first sealing device (182) can prevent water from entering into the space between the shell (111) and the first and second caps (131, 132), they can protect the generator module (120) located inside from the moisture.

According to one embodiment, the second sealing device (127) can be interposed between the inner housing (121) and the rotating shaft (124). As depicted in FIG. 3, the second sealing device (127) can be located between the fourth bearing (126) and the third gear (153). In case some water enters the inner housing (121), the second sealing device (127) can prevent the entry of water into the stator (122) or the rotor (123).

According to one embodiment, the third sealing device (128) can be interposed between the inner cap (170) and the inner housing (121). As depicted in FIG. 4, the third sealing device (128) can be located between the end of the second part (172) of the inner cap (170) and the end of the first part (1211) of the inner housing (121). As such, the third sealing device (128) prevents the entry of water into the space between the end of the second part (172) and the end of the first part (1211).

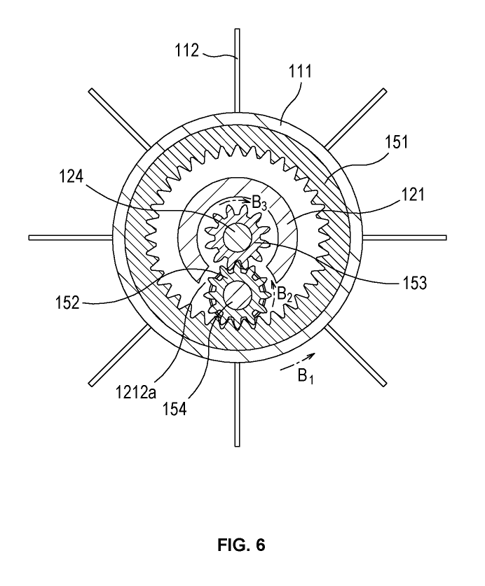

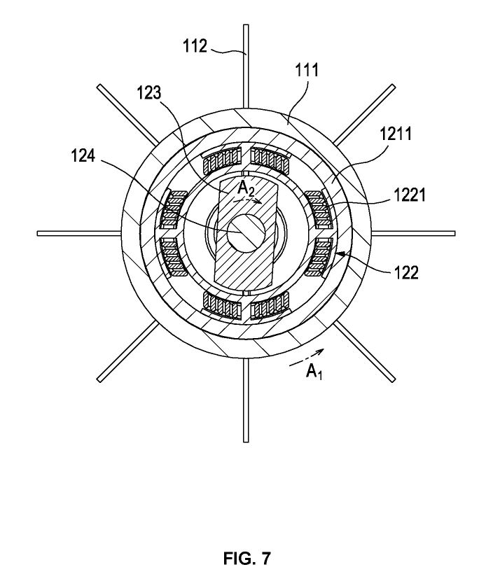

FIG. 6 is a cross-sectional view of the hydroelectric device (100) of FIG. 2, taken along the direction of II-II, and FIG. 7 is a cross-sectional view of the hydroelectric device (100) of FIG. 2 along the direction of III-III. FIG. 6 depicts a cross-sectional view of the portion of the hydroelectric device (100) where the step-up gear device (150) is located, and FIG. 7 depicts a cross-sectional view of the middle portion of the generator module (120) of the hydroelectric device (100). The description of the operations of the hydroelectric device (100) is provided below with reference to FIGS. 3 through 5.

As depicted in FIG. 6, the shell (111) rotates in the direction of B1 as the fins/wings (112) have power applied onto them by the flowing water. The direction of B1 can be, for example, counter-clockwise. At the same time, the first gear (151) that is coupled to the inner circumference of the shell (111) rotates in the same direction of B1. In addition, the second gear (152) that is engaged with the first gear (151) rotates together with the rotating shaft (154) in the direction of B2 that is the same as the direction of B1. As a groove (1212a) is formed on the end of the inner housing (121), the second gear (152) can rotate freely without interfering with the inner housing (121). Furthermore, the third gear (153) that is engaged with the second gear (152) can rotate together with the rotating shaft (124) in the direction of B3. Here, the direction of B3 is opposite to the direction of B1 and B2 , for example, when the direction of B1 and B2 is counter-clockwise, the direction of B3 is clockwise. Through the above-described process, the rotation of the shell (111) can result in the rotation of the rotating shaft (124). However, even if the shell (111) rotates, the inner housing (121) does not rotate.

Referring to FIG. 7, the shell (111) can rotate in the direction of Al as the fins/wings (112) have power applied onto them by the flowing water. At the same time, the rotor (123) and the rotating shaft (124) can rotate inside the stator (122) in the direction of A2 that is opposite to the direction of Al. The rotor (123) can include magnetic materials, and as it rotates inside the stator (122), the direction of the magnetic field applied to the coils (1221) continually changes, which can result in the generation of electrical energy through the induction of an electrical current.

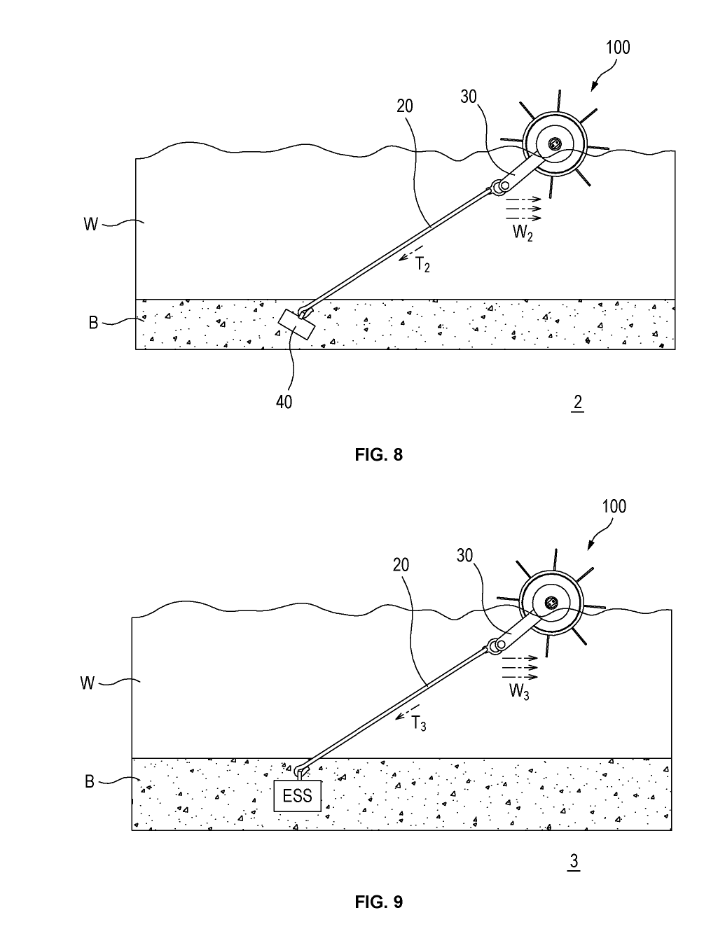

FIG. 8 is a perspective view of a hydroelectric generator (2) according to another embodiment of the present disclosure. A duplicate description/explanation of the hydroelectric device (100) as described above in connection with FIGS. 1 through 7, is omitted here.

According to one preferred embodiment, a hydroelectric generator (2) can include a weighting device (40) that is substantially heavier than the flowing water, a connecting device (20) that is connected with one end to the weighting device (40) and with the other end to the hydroelectric device (100) via the holding device (30), where the holding device (30) holds the inner housing (121) so as to prevent the rotation of the inner housing (121) relative to the rotation of the housing (110). For the hydroelectric generator (2), the function of the fixed pillar (10) as depicted in FIG. 1 can instead be fulfilled by the weighting device (40).

The weighting device (40) can be buried in the bed (B) of the flowing water. As such, in case where the flowing water flows in the direction of W2, the holding device (30) can be pulled in the direction of T2. As depicted in FIG. 3, the holding device (30) can hold the non-rotating portion inside of the hydroelectric device (100) so as to prevent it from rotating, and the hydroelectric device (100) can convert the rotational energy of the housing (110) into electrical energy. Besides the methods of fixing the holding device (30) using the weighting device (40) as depicted in FIG. 8 or by the fixed pillar (10) as depicted in FIG. 1, the hydroelectric device (100) can be configured to have the holding device (30) fixed or kept in a given location through any other methods that can allow the holding device (30) to hold the non-rotating portion of the hydroelectric device (100) so that the rotating portion of the hydroelectric device (100) can rotate relative to the non-rotating portion.

FIG. 9 is a perspective view of a hydroelectric generator (3) according to another embodiment of the present disclosure. A duplicate explanation of the hydroelectric device (100) as described above in connection with FIGS. 1 through 7 is omitted herein.

According to one preferred embodiment, the hydroelectric generator (3) can include an electrical energy storage device (ESS). The electrical energy storage device (ESS) can store the electrical energy generated by the hydroelectric device (100) as it is electrically connected to the hydroelectric device (100). As illustrated in FIG. 9, the coils (1221, described above) and the electrical energy storage device (ESS) can be electrically connected to each other.

The electrical energy storage device (ESS) can be buried in the bed of the flowing water. As such, in cases where the flowing water flows in the direction of W3, the holding device (30) can be pulled in the direction of T3. As depicted in FIG. 3, the holding device (30) can hold the non-rotating portion of the hydroelectric device (100) so as to prevent it from rotating, and the hydroelectric device (100) can convert the rotational energy of the rotating housing (110) into electrical energy.

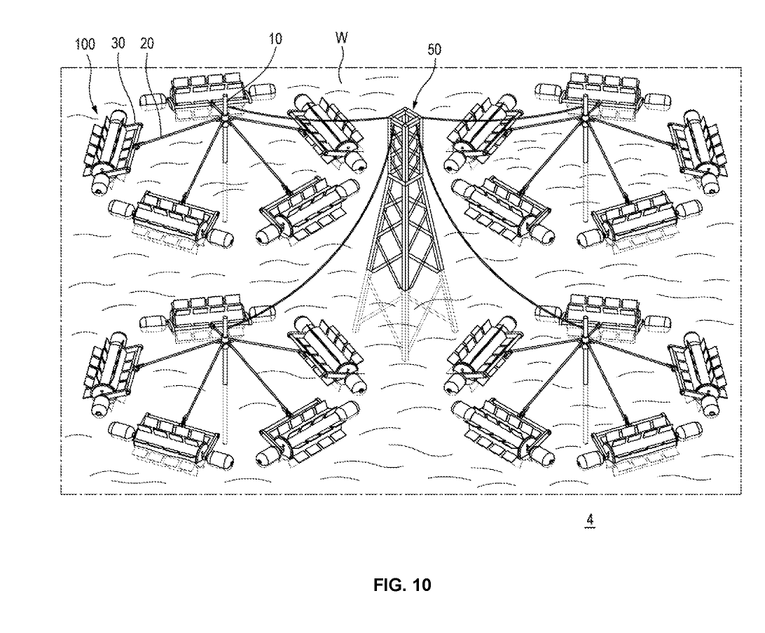

FIG. 10 illustrates a perspective view of a hydroelectric system (4) according to another embodiment of the present disclosure. A duplicate explanation of the hydroelectric device (100) as described above in connection with FIGS. 1 through 7 is omitted herein.

The hydroelectric system (4) can be composed with a plurality of hydroelectric devices (100) so as to effectively harvest energy from the flowing water (W). The hydroelectric system (4) can include a plurality of fixed pillars (10) that are fixed to the bed of the flowing water, a plurality of hydroelectric devices (100) that are connected to the plurality of fixed pillars (10), and a transmission device (50) that transmits the electrical energy generated by the plurality of hydroelectric devices (100) to a desired location. A plurality of connecting devices (20) are connected to the fixed pillars (10), and a holding device (30) is connected to each of the connecting devices (20) so as to hold its corresponding one of the hydroelectric devices (100) in the same or similar manner as described above.

The transmission device (50) collects the electrical energy generated by the hydroelectric devices (100) and can transmit it to land or other locations. In such a case, as large scale installations such as dams are not required, the generation of electrical energy can be improved through the easily installation of hydroelectric devices (100), and this can solve the locational limitations of the conventional hydroelectric apparatuses.

While the technical concept behind the present disclosure has been explained through the foregoing embodiments and the examples and with reference to the attached drawing figures, it must be understood that a diverse set of substitutions, transformations, and modifications can be made while and to the extent that does not exceed the technical scope and concept behind the present disclosure as understood by a person having ordinary knowledge of the technical field that pertains to the present disclosure. Such substitutions, transformations, and modifications must be understood to be within the scope of the attached claims.

Legend of References:

1, 2, 3: Hydroelectric generator

4: Hydroelectric system

100: Hydroelectric device

110: Housing

120: Generator module

130: Cap

140: Flotation device

150: Step-up gear device

What is claimed is:

1. A hydroelectric generator comprising:
a housing having a plurality of wings affixed thereto to enable the housing to rotate in flowing water in which the housing is to be placed;
a generator module disposed in the housing, the generator including a rotating shaft rotatable by the rotation of the housing so as to convert a rotational energy of the rotating shaft to electrical energy; and
first and second flotation devices coupled to the housing to allow the hydroelectric generator to float in the flowing water.

2. The hydroelectric generator according to claim 1, further comprising first and second caps installed to first and second ends of the generator module, respectively, to prevent the flowing water from entering the generator module.

3. The hydroelectric generator according to claim 2, wherein the generator module further comprises:
an inner housing disposed in the housing;
a stator installed within the inner housing and having coils; and
a rotor including a permanent magnet and rotating along with the rotating shaft relative to the stator.

4. The hydroelectric generator according to claim 3, further comprising:
a fixed pillar affixed to a bed of the flowing water;
a connecting device having first and second ends, the first end of the connecting device connected to the fixed pillar; and
a holding device connected to the second end of the connecting device, the holding device configured to hold the inner housing of the generator module so that the inner housing is prevented from rotating in association with the housing.

5. The hydroelectric generator according to claim 4, wherein the connecting device is configured to pull the holding device in a direction opposite to a flowing direction of the flowing water.

6. The hydroelectric generator according to claim 3, further comprising:
a weighting device that is heavier than the flowing water;
a connecting device having first and second ends, the first end of the connecting device connected to the weighting device; and
a holding device connected to the second end of the connecting device, the holding device configured to hold the inner housing of the generator module so that the inner housing is prevented from rotating in association with the housing.

7. The hydroelectric generator according to claim 2, wherein the housing is an impeller housing that has a cylindrical shell to which the plurality of wings are integrally affixed on the outer surface of the shell.

8. The hydroelectric generator according to claim 3, further comprising a step-up gear device configured to increase a rotation speed of the rotating shaft, wherein the step-up gear device comprises:
a first gear having an outer circumference coupled to the housing so as to rotate along with the housing, and an inner circumference having gear teeth;
a second gear configured to engage with the first gear; and
a third gear configured to engage with the second gear and rotate along with the rotating shaft.

9. The hydroelectric generator according to claim 8, wherein the diameter of the first gear is larger than the diameter of each of the second gear and the third gear.

10. The hydroelectric generator according to claim 8, wherein the rotating shaft of the second gear is affixed to the inner housing.

11. The hydroelectric generator according to claim 3, further comprising an inner cap located between the inner housing and the first cap and configured to close off one end of the inner housing.

12. The hydroelectric generator according to claim 3, further comprising:
a first bearing disposed between the housing and the inner housing and allowing the housing to rotate about the inner housing.

13. The hydroelectric generator according to claim 11, further comprising:
a second bearing disposed between the housing and the inner cap and allowing the housing to rotate about the inner cap.

14. The hydroelectric generator according to claim 11, further comprising:
a third bearing disposed between the inner cap and the rotating shaft, and a fourth bearing disposed between the inner housing and the rotating shaft.

15. The hydroelectric generator according to claim 2, further comprising:
a first sealing device disposed between the cap and the housing.

16. The hydroelectric generator according to claim 3 further comprising:
a second sealing device disposed between the rotating shaft and the inner housing of the generator module.

17. The hydroelectric generator according to claim 11, further comprising:
a third sealing device disposed between the inner cap and the inner housing.

18. The hydroelectric generator according to claim 2, further comprising an electrical energy storage device buried in a bed of the flowing water,
wherein the electrical energy storage device is electrically connected to the generator module so that the electrical energy generated by the generator module is stored in the electrical energy storage device.

19. A hydroelectric system for harvesting electrical energy from flowing water, comprising:
a plurality of fixed pillars affixed to a bed of the flowing water;
a plurality of hydroelectric devices connected to each of the fixed pillars; and
a transmission device for transmitting an electrical energy generated by the hydroelectric devices to a selected location,
wherein each of the hydroelectric devices comprises:
a housing having a plurality of wings affixed thereto to enable the housing to rotate in flowing water in which the housing is to be placed;
a generator module disposed in the housing, the generator including a rotating shaft rotatable by the rotation of the housing so as to convert a rotational energy of the rotating shaft to electrical energy; and
first and second flotation devices coupled to each of the hydroelectric devices to allow the housing and the generator module to float in the flowing water.

20. The hydroelectric system according to claim 19, wherein each of the hydroelectric devices further comprises first and second caps installed to first and second ends of the generator module, respectively, to prevent the flowing water from entering the generator module.
